(19) United States
(12) Patent Application Publication
(10) Pub. No.: US 2007/0120884 A1
(43) Pub. Date: May 31, 2007

(54) Method and device for regulating the temperature of a print head

(76) Inventor: Ammar Lecheheb, Cambridge (GB)

Correspondence Address: MCANDREWS HELD & MALLOY, LTD, 500 WEST MADISON STREET, SUITE 3400, CHICAGO, IL, 60661, US

(21) Appl. No.: 10/567,546

(22) PCT Filed: Aug. 2, 2004
(86) PCT No.: PCT/GB04/03321

§ 371 Date: Dec. 5, 2006

(30) Foreign Application Priority Data
Aug. 6, 2003 (GB) 0318417.3

(51) Int. Cl. B41J 29/38

(52) U.S. Cl. 347/17

(57) ABSTRACT

A printing device is disclosed, and a method of its operation, in which a medium is used to regulate the temperature of one or more print elements. Preferably the medium is an ink or print medium.

The present invention relates to a method of and device for regulating the temperature of printing devices, and in particular devices comprising one or more arrays of ink jet valves.

Printers are used, to give just one example, to print onto a print substrate such as products and packaging on assembly lines, carpets, fabrics, etc. Print heads comprising arrays of many print elements are arranged together to print across a defined region of the print substrate. If the printing is in colour then it is necessary to have print heads that can print in black, cyan, magenta and yellow.

According to a first aspect of the present invention there is provided a method of regulating the temperature of a print head comprising one or more print elements, the method comprising the step of using a temperature control medium to regulate the temperature of one or more of the print elements.

The temperature control medium may be pumped from a storage means to the one or more print elements and/or the temperature control medium may be pumped from the one or more print elements back to the storage means. Preferably, the temperature of the print head is regulated based on the temperature difference between the temperature control medium pumped from the storage means to the one or more print elements and the temperature control medium pumped from the one or more print elements back to the storage means. The temperature control medium may also be a print medium and preferably an ink.

According to a second aspect of the present invention there is provided a print head comprising: one or more print elements; temperature control medium storage means, the storage means being in fluid communication with the one or more print elements such that, in use, temperature control medium can circulate from the storage means to the one or more print elements and thence to the storage means.

Preferably the print head further comprises temperature control means that, in use, heats or cools the temperature control medium held in the storage means. The print head may further comprise a first conduit for providing fluid communication from the storage means to the printing elements and a second conduit fro providing fluid communication from the printing elements to the storage means. Preferably the print head comprises one or more temperature sensors. The one or more temperature sensors may be arranged to measure the temperature of one or more print elements and/or one or more temperature sensors may be arranged to measure the temperature of the temperature control medium in the first conduit and or the second conduit.

A preferred embodiment of the invention control will now be described by way of illustration only and with respect to the accompanying drawings, in which

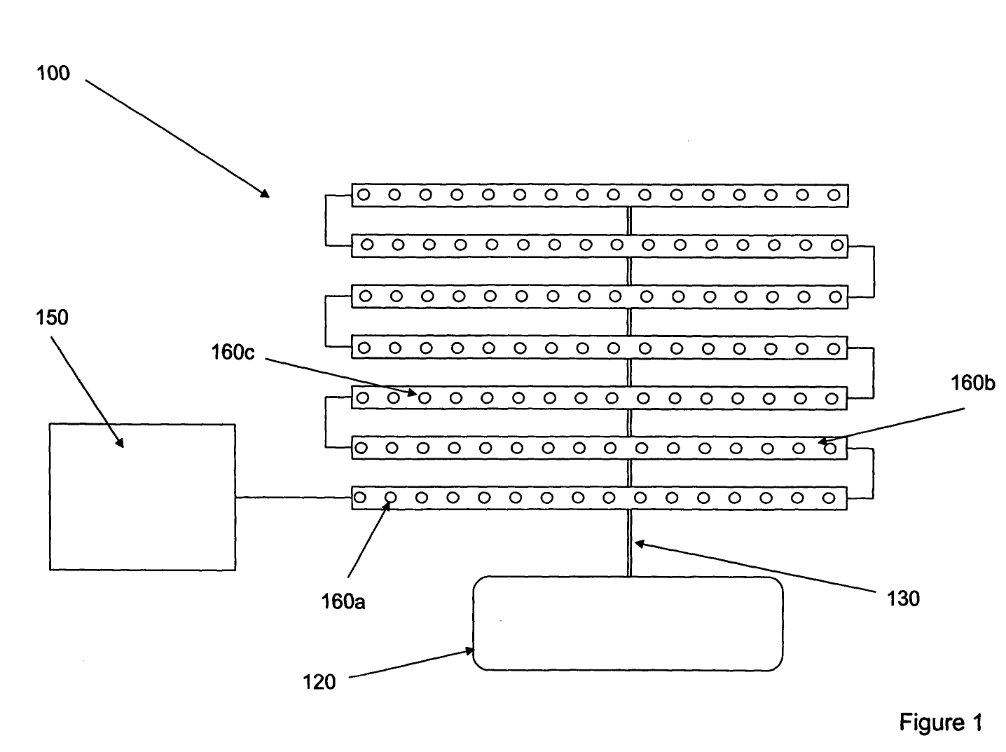

FIG. 1 shows a schematic depiction of a known print head; and

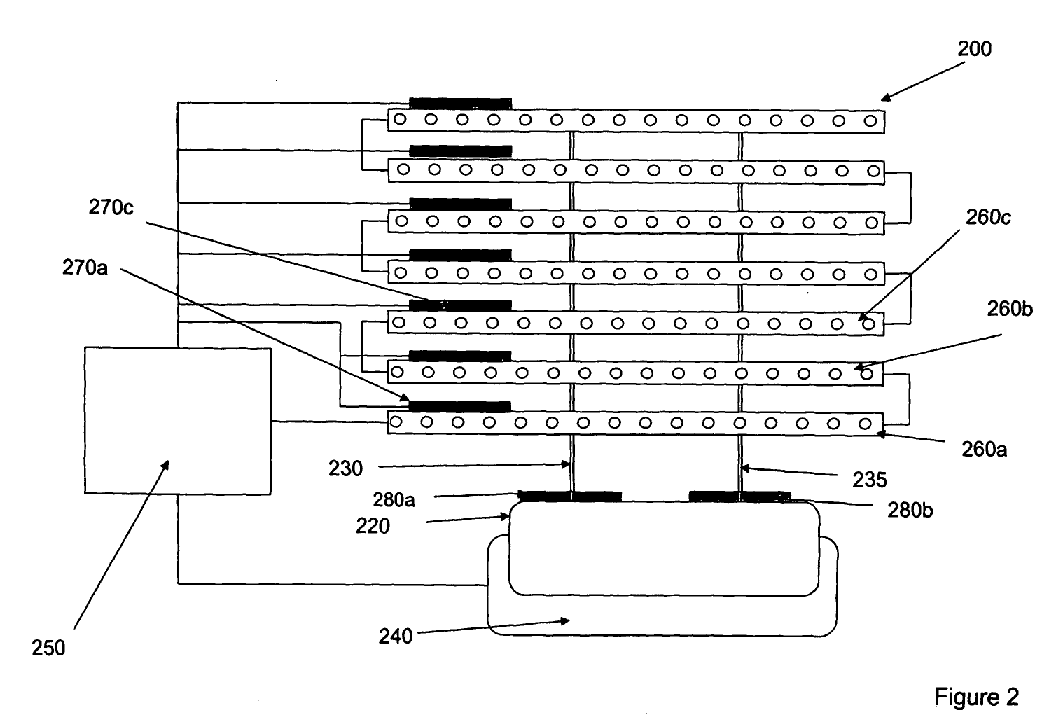

FIG. 2 shows a schematic depiction of a print head according to the present invention.

FIG. 1 shows a schematic depiction of print head 100 comprising control means 150 and rows 160a, 160b, 160c . . . of printing elements. The rows of printing elements are physically located in a vertical array so that the valves can deposit a two-dimensional matrix on a print substrate The print head further comprises ink reservoir 120 and ink conduit 130 such that ink can be supplied from the reservoir to the printing elements. Each element may be individually connected to the conduit or there may be a manifold associated with each of the rows of printing elements such that the conduit is connected to each row of printing elements.

Modern printing technology enables printing at very high speeds, for example in excess of 1 kHz (see, for example, WO03/033951, PCT/GB2003/000633 and GB 0316266.6) and for the electromagnetic valves used, for example, in drop-on demand ink jet printers the drive circuits generate significant amounts of heat. When a number of print heads are closely arranged together, and especially when colour printing is used, it is difficult to provide adequate cooling to the print heads by blowing cool air over the print heads.

If the print heads overheat then this can have serious effects on the print quality as the electronic circuits may be damaged (or may fail) and the ink properties may be affected, for example the viscosity of the ink may be decreased such that it is no longer suitable for the printing application, or the long-term stability of the pigments in the ink may be affected.

FIG. 2 shows a schematic depiction of a print head 200 according to the present invention. The print head comprises control means 250, rows 260a, 260b, 260c . . . of printing elements located in a vertical array so that the valves can deposit a two-dimensional matrix on a print substrate, ink reservoir 220 and first ink conduit 230. The print head further comprises second ink conduit 235 and temperature control means, which is coupled to the ink reservoir.

In operation, the ink is pumped from the ink reservoir to the rows of printing elements via the first ink conduit. When a printing element is operated some ink will be expelled from the printing element and onto the print substrate and the ink pumped from the reservoir will replace the ink used in printing. Furthermore, some of the ink will be returned to the ink reservoir via the second ink conduit, from where the ink may be re-circulated again.

If the operation of the print head, and other adjacent or proximate print heads, causes the temperature of the print heads to increase then the temperature of the ink in the second conduit will be greater than that of the ink in the first conduit. The ink may thus be used as a heating or a cooling medium with the temperature control means regulating the temperature of the ink held within the ink reservoir before it is then re-circulated via the first ink conduit. By suitable control of the temperature control means, and thus the temperature of the ink, the flow of cooled ink to the print elements and then back to the ink reservoir, via the first conduit and the second conduit, enables the temperature of the print elements to be regulated.

The temperature of the print elements may, in one embodiment of the invention, be inferred by measuring the temperature of the ink as it enters the first conduit from the ink reservoir and as it returns to the ink reservoir from the second conduit. In this case ink temperature sensors 280a, 280b may be used to measure the temperature of the ink passing through the first and second conduit respectively. It may be possible to assume the temperature of the ink in the storage means and infer the temperature of the print elements solely based on the temperature of the ink in the second conduit.

In a preferred embodiment of the invention, the print head further comprises one or more temperature sensors 270a, 270b, 270c, . . . located on or near to the print element.

Although FIG. 2 shows one temperature sensor being attached to each of the circuit boards to which the print elements are attached, it will be understood that one or more temperature sensors may be attached to one or more of the circuit boards or one or more of the print elements. The data from the temperature sensors is polled by the control means 250 and this data is used to manage the temperature control means. It will be understood that some of the print elements may be significantly hotter than other print elements. In this case additional parallel fluid conduits may be provided in order to supply the necessary cooling to those print elements.

It will be understood that any cooling mechanism may be used to cool the temperature of the ink reservoir as long it is able to provide adequate cooling to the reservoir. Examples of suitable technologies include, without limitation, heat-sinks and fans mounted on the reservoir, thermo-electric coolers, heat exchangers integrated with the reservoir, pumping hot ink into a radiator which may be further cooled, etc. Furthermore it will be readily understood that there may be some scenarios in which it is necessary to heat the ink, for example to maintain the viscosity of the ink within a pre-determined range and in this case the temperature control means may further comprise heating means, for example one or more electrical heating elements.

The invention is applicable to all manner of print heads that use ink and for which temperature regulation may be required, and not just drop-on demand ink-jet printers.

1-9. (canceled)

10. A method of regulating the temperature of a print head comprising one or more print elements, the method comprising the steps of:
providing a temperature control medium that is also a print medium;
pumping a temperature control medium from a storage reservoir to the one or more print elements; and
regulating the temperature of the temperature control medium to regulate the temperature of the print head.

11. The method of claim 1, further comprising the step of pumping the temperature control medium from the one or more print elements back to the storage reservoir.

12. The method of claim 11, wherein the temperature of the control medium and hence the print head is regulated based on a temperature difference between the temperature control medium pumped from the storage reservoir to the print elements and the temperature control medium pumped from print elements to the storage reservoir.

13. The method of claim 1, wherein the temperature control medium is an ink.

14. A print head comprising:
one or more print elements;
a storage reservoir for holding a temperature control medium that also is a print medium, the storage reservoir being in fluid communication with the one or more print elements such that, during printing, the temperature control medium can circulate from the storage reservoir to the one or more print elements and then back to the reservoir;
a temperature control means for regulating the temperature of the temperature control medium that flows from the reservoir to the print elements so as to regulate the temperature of the print head.

15. A print head as set forth in claim 14, further comprising a first conduit connected to provide fluid communication from the storage reservoir to the printing elements and a second conduit for providing fluid communication from the printing elements to the storage reservoir.

16. A print head as set forth in claim 15, further comprising a first temperature sensor arranged to sense the temperature in the first conduit and a second temperature sensor arranged to sense the temperature in the second fluid conduit.

17. A print head as set forth in claim 14, further comprising at least one temperature sensor arranged to measure the temperature of the one or more print elements.

18. A print head as set forth in claim 14, wherein the temperature control means regulates the temperature of the temperature control medium in the reservoir.

19. A print head comprising:
one or more print elements;
a storage reservoir for holding a temperature control medium that also is a print medium, the storage reservoir being in fluid communication with the one or more print elements such that, during printing, the temperature control medium can circulate from the storage reservoir to the one or more print elements and then back to the reservoir;
a first temperature sensor arranged to measure the temperature of the temperature control medium that is communicated from the reservoir to the print elements;
a second temperature sensor arranged to measure the temperature of one of the print control head and the temperature control medium that is returned from the print elements;
a temperature controller coupled to the first and second temperature sensors and to the reservoir, the temperature controller being adapted to sense the temperatures measured by the first and second sensors and to regulating the temperature of the temperature control medium in the reservoir in response to the measured temperatures so as to regulate the temperature of the print head.

20. A print head as set forth in claim 19, wherein the temperature control medium is an ink.
